(19) United States
(12) Patent Application Publication
(10) Pub. No.: US 2011/0051479 A1
(43) Pub. Date: Mar. 3, 2011

(54) Systems and Methods for Controlling Phases of Multiphase Voltage Regulators

(75) Inventors: John Breen, Harker Heights, TX (US); Shiguo Luo, Austin, TX (US)

(73) Assignee: DELL PRODUCTS L.P.

(21) Appl. No.: 12/548,582

(22) Filed: Aug. 27, 2009

(51) Int. Cl. H02M 5/02; G06F 1/26

(52) U.S. Cl. 363/148; 713/340

(57) ABSTRACT

A multi-phase voltage regulator is disclosed. The multi-phase voltage regulator includes a voltage regulator controller. Phase output stages are coupled to the voltage regulator controller. The voltage regulator controller and the phase output stages are configured to provide regulated voltages at one or more output nodes. The voltage regulator controller is configured to monitor one or more conditions of the phase output stages and to control one or more of the phase output stages based, at least in part, on the one or more conditions.

### TECHNICAL FIELD

The present disclosure relates generally to information handling systems and, more particularly, to systems and methods for controlling the regulated voltage provided by voltage regulators to circuitry in information handling systems.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Information handling systems have used direct-current-to-direct-current (DC-DC) voltage regulators (VRs) to provide regulated voltages to various circuitry and devices such as central processing units (CPUs) and memory. As the range of information handling system configurations continues to expand, the range of corresponding power requirements of those configurations also expands. To accommodate wide configuration ranges, VRs have been designed to include a plurality of power stages that work together to form a multiphase VR. Power stages may be added in a stackable fashion in implementing voltage regulation to accommodate power demand. A number of phases of a VR may be selected based on the power requirements of a given information handling system. A typical multiphase VR may be designed to support a maximum load based on a maximum number of components to be included in a configuration. However, a voltage regulator designed for a maximum load may be substantially inefficient at loads less than a maximum load.

A technique of phase shedding, or phase dropping, has been promoted as a means to improve VR efficiency across a given load range. One or more phases may be shed—i.e., turned off—to address a load that is less than the maximum design load. However, VRs of phase shedding applications may be vulnerable to fault conditions. There is a need to provide for handling fault conditions and re-enabling phases under fault conditions, which may include, for example, an open phase, a shorted phase, a thermal overload, or exceeding thermal capability under conditions where operating factors other than power or current, such as printed circuit board (PCB) temperature and air flow, are considered. In addition, there is a need to provide monitoring or reporting of individual phase power signals and of output ripple voltage to ensure VR health prior to disabling phases, which could lead to data loss in some cases.

### SUMMARY

In one aspect, a method for controlling a multi-phase voltage regulator is disclosed. The method includes activating one or more phases for the multi-phase voltage regulator. The method further includes detecting one or more conditions of the multi-phase voltage regulator. The method further includes activating one or more inactive phases based, at least in part, on the one or more conditions. The method further includes controlling the multi-phase voltage regulator to provide regulated voltages to a load coupled to one or more output nodes of the multi-phase voltage regulator.

In another aspect, a multi-phase voltage regulator is disclosed. The multi-phase voltage regulator includes a voltage regulator controller. Phase output stages are coupled to the voltage regulator controller. The voltage regulator controller and the phase output stages are configured to provide regulated voltages at one or more output nodes. The voltage regulator controller is configured to monitor one or more conditions of the phase output stages and to control one or more of the phase output stages based, at least in part, on the one or more conditions.

In another aspect, an information handling system is disclosed. The information handling system includes a computer motherboard coupled to one or multi-phase voltage regulator more processors, and a multi-phase voltage regulator coupled to the computer motherboard. The multi-phase voltage regulator includes phase output stages coupled to a voltage regulator controller, where the voltage regulator controller and the phase output stages are configured to provide regulated voltages at one or more output nodes. The voltage regulator controller is configured to monitor one or more conditions of the phase output stages and to control one or more of the phase output stages based, at least in part, on the one or more conditions.

Thus, the systems and methods disclosed herein enable a high-efficiency, high-reliability power architecture. This disclosure provides for more intelligent VR embodiments that may include real-time monitoring or reporting of individual phase power signals and/or of output ripple voltage to ensure VR health prior to and/or after disabling and/or re-enabling one or more phases. This disclosure further provides for handling thermal conditions of phase shedding applications, factoring thermal considerations into a VR control loop, and handling thermal conditions in cases where possible thermal issues may arise for relatively low-end load phase shedding applications. This disclosure provides for handling fault conditions, for re-enabling phases under fault conditions, and for a high reliability VR where one or more disabled phases may act as redundant phases and may be re-enabled based on various fault conditions. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram for a circuit configuration for a single phase voltage regulator;

FIG. 2 is a block diagram of an embodiment in high-level for a phase shedding system for controlling a multiphase voltage regulator;

FIG. 3 is a block diagram of an embodiment in detail for a phase shedding system for controlling a 3 phase voltage regulator;

FIG. 4 is a graph of exemplary data showing efficiencies for different numbers of phases for a 3 phase voltage regulator with respect to different current loads;

FIG. 5 is a graph of exemplary data showing power savings between different numbers of phases for a 3 phase voltage regulator with respect to different current loads; and

FIG. 6 is a process flow diagram illustrating control of one or more phases of a multiphase voltage regulator in accordance with certain embodiments of the present disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

Certain embodiments for managing voltage regulators (VRs) disclosed herein may enable an intelligent, high-efficiency, high-reliability power architecture. Certain embodiments may provide for handling thermal conditions, fault conditions, disabling, and/or re-enabling phases under fault conditions, which may include, e.g., an open phase, a shorted phase, a thermal overload, or exceeding thermal capability under conditions where operating factors other than power or current, such as printed circuit board (PCB) temperature and air flow, are considered. Certain embodiments disclosed herein may provide real-time monitoring and/or reporting of individual phase power signals and/or of output ripple voltage to ensure VR health prior to disabling phases and/or re-enabling one or more phases.

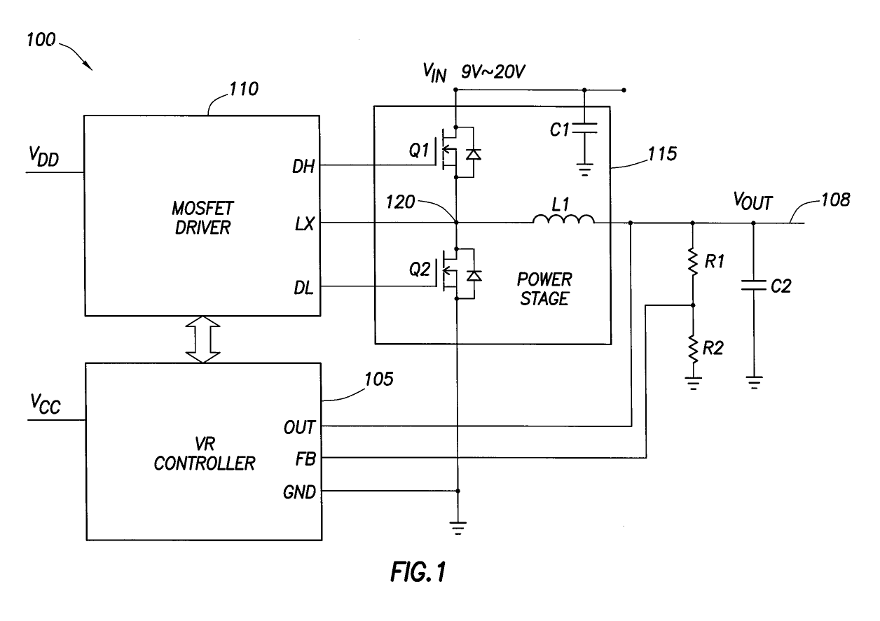

FIG. 1 shows a DC-DC voltage regulator (VR) 100 that may include VR controller 105, one or more MOSFET (metal oxide semiconductor field effect transistor) drivers 110 and one or more power stages 115. A power stage 115 may include MOSFETs Q1 and Q2 and an inductor L1. MOSFET driver 110 may receive a regulated power supply V_{DD} and provide signals to power stage 115. Power stage 115 may include a MOSFET Q1 driven by the DH signal, a second MOSFET Q2 driven by the DL signal, and an inductor L1 which one terminal is connected to the node of driver LX signal and MOSFETs, and other terminal to output Vout. MOSFET Q1 may be coupled between a voltage input (Vin) (e.g., 9 to 20 volts) and node 120. MOSFET Q2 may be coupled between node 120 and ground. Inductor L1 may be coupled between node 120 and the output voltage node Vout. A capacitor C1 may couple −Vin to ground, and a capacitor C2 may couple Vout to ground. VR controller 105 may receive a separate power supply V_{CC} and operate to control MOSFET driver 110. Resistors R1, R2 coupled between Vout and ground may provide a divided voltage as a feedback (FB) signal to VR controller 105. VR controller 105 may also have a ground connection GND to ground, and an output connection OUT to Vout. V_{CC} and V_{DD} may be bias power supplies for VR controller 105 and MOSFET driver 110, respectively, and these power supplies may be drawn from Vin or from different voltage source, as desired. Information handling systems have used VRs such as VR 100 to provide regulated voltages to various circuitry and devices such as CPUs and memory.

However, a range of power requirements of an information handling system may expand according to the system configuration. For example, a given mainstream server may support 1, 2 or more CPUs, 1 to 18 or more dual in-line memory modules (DIMMs), and other various components in various quantities. As would be appreciated by one of ordinary skill in the art, 1 to 2 CPUs may correspond to exemplary power ratings of approximately 40 W TDP (watts thermal design point) to 190 W TDP, and 1 to 18 DIMMs may correspond to approximately 1 W TDP to 190 W TDP. To accommodate wide configuration ranges, VRs may have a plurality of power stages that work together to form a multiphase VR. Power stages may be added in a stackable fashion in implementing voltage regulation to accommodate power demand. A number of phases of a VR may be selected based on the power requirements of a given information handling system. A multiphase VR may be designed to support a maximum load based on a maximum number of components to be included in a configuration, but such a VR may be substantially inefficient at loads less than a maximum load. For example, a user may employ a low-end application that includes fewer than the maximum number of components that the VR may be designed to support, which may lead to inefficiencies across the user's load range.

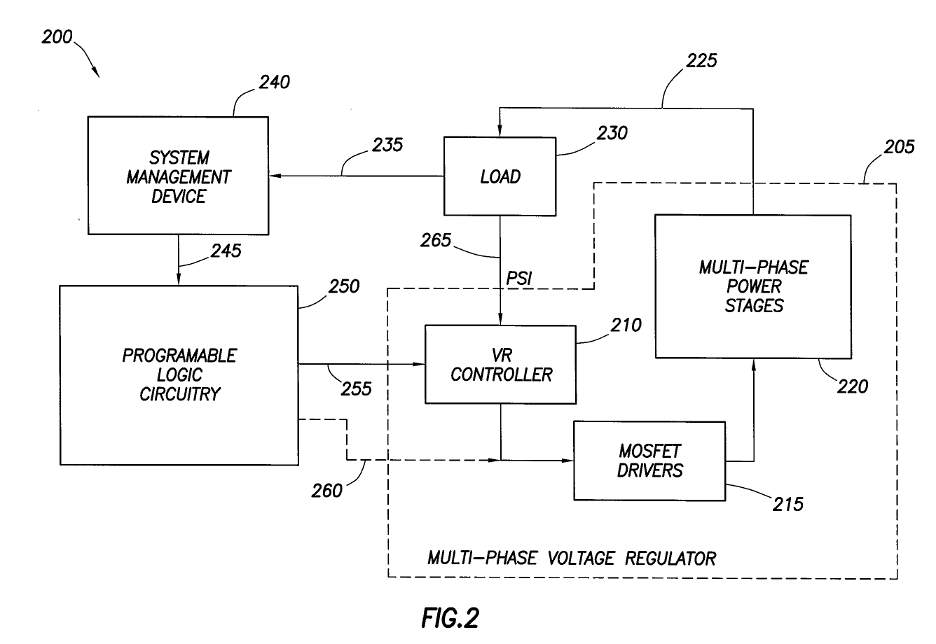

Phase shedding, or phase dropping, may improve VR efficiency across a given load range. One or more phases may be shed—i.e., turned off—to address a load that is less than the maximum design load. A phase shedding technique may be static or dynamic. Static phase shedding may be based on a particular configuration of CPUs, memory, etc. FIG. 2 shows a block diagram of a phase shedding system 200 for controlling a multiphase voltage regulator. A multiphase VR 205 may include a VR controller 210, MOSFET drivers 215, and multi-phase power stages 220. VR 205 may provide regulated voltages to circuitry represented by load 230 through VR lines 225. Load 230 may include one or more CPUs and one or more DIMMs, for example, and may be coupled to a system management device (SMD) 240, such as a board management controller (BMC), via lines 235. SMD 240 may be coupled to programmable logic circuitry (PLC) 250, such as a CPLD (complex programmable logic device) configured to provide phase control, via control signal lines 245. PLC 250 may be coupled to VR controller 210 via phase control signal lines 255. VR controller 210 may provide phase control signals to MOSFET drivers 215. MOSFET drivers 215 may drive MOSFETs within multiphase power stages 220. Alternatively, PLC 250 may provide phase control signal via optional control lines 260. The phase control signals from MOSFET drivers 215 may determine a number of active phases for multiphase VR 205.

Dynamic phase shedding may be employed to enable or disable phases based on a processor's power status indicator (PSI) during operation or operating current prediction derived from an internal CPU algorithm. Dynamic phase shedding may be included in conjunction with the static phase shedding system 200. As depicted in FIG. 2, where the load 230 includes a CPU, the CPU may also report a power state indicator (PSI) signal 265 to the VR controller 210. PSI signal 265 may be used to reduce or increase the number of active phases when the CPU transitions between high and low power states during its operation, such as when the CPU transitions between normal operation and standby/sleep power modes.

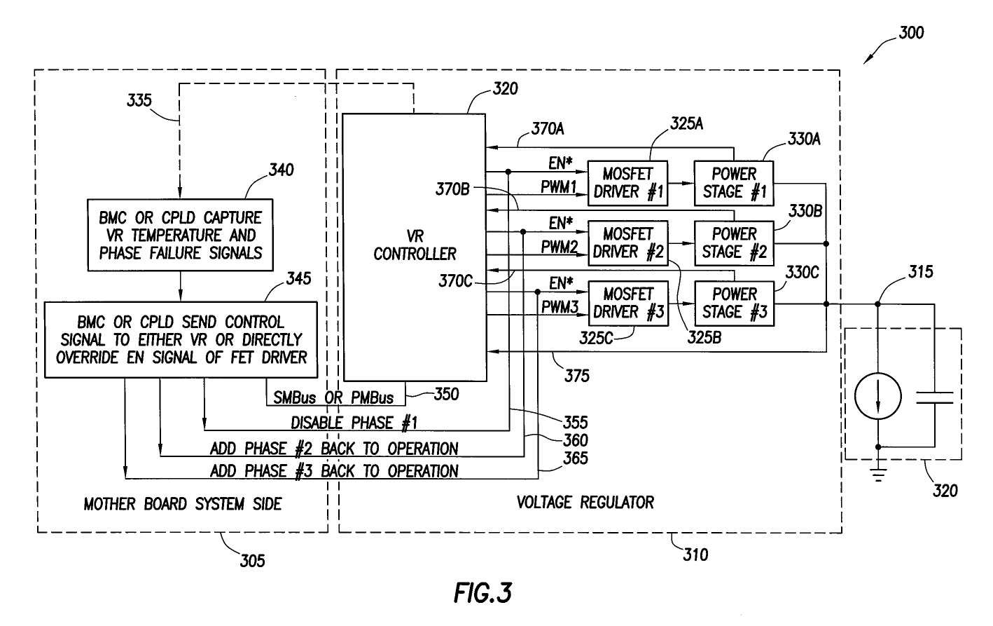

FIG. 3 is a more detailed block diagram for an example static phase shedding system 300. System 300 may include mother board system side processes 305 and a VR 310. The mother board system side 305 describes processes that occur in disabling and/or enabling a number of active phases for the VR 310. VR 310 produces a regulated voltage output 315 that drives a load 320. Although load 320 is represented by a current source and a capacitor, load 320 may comprise various devices and circuitry in various quantities, such as a number of CPUs and/or DIMMs.

As illustrated in FIG. 3, VR 310 may be configured as a 3-phase VR coupled to three power stages 330A, B and C through three MOSFET drivers 325A, B and C. VR 310 may include VR controller 320 coupled to MOSFET drivers 325A, B and C, and associated power stages 330A, B and C, using a plurality of enable (EN*) signals and pulse width modulation (PWM) signals. As depicted, enable signals EN* may be active low signals. Considering one phase as an example, VR controller 320 may be configured to provide an enable signal EN* and a PWM1 signal to MOSFET driver 325A, which in turn drives power stage 330A to provide VR signals to VR output node 315. Although FIG. 3 illustrates an exemplary configuration for 3 phase output stages, other embodiments may employ different numbers of phase output stages.

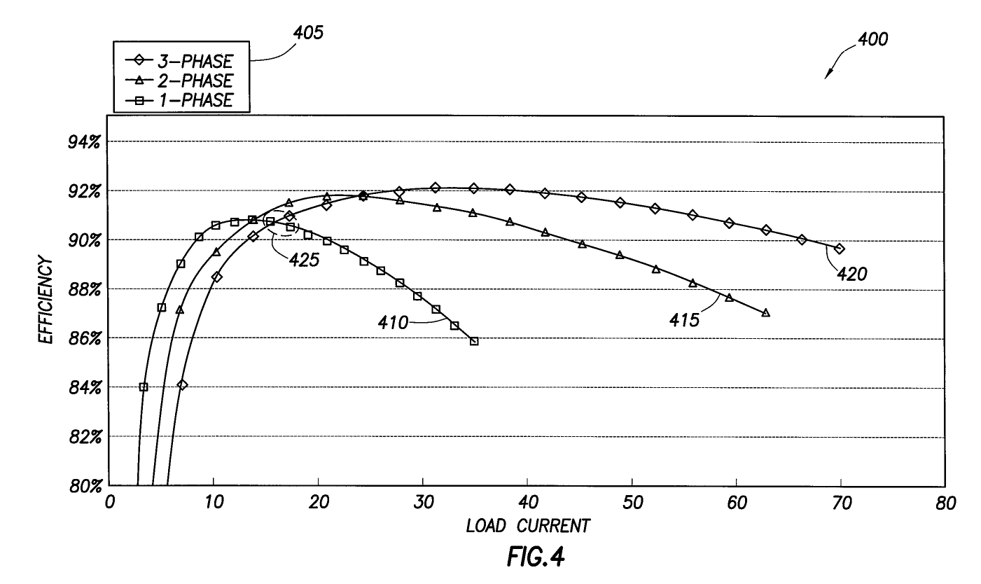

Turning now to FIG. 4, graph 400 depicts exemplary test data for a 3-phase memory VR. Graph 400 shows efficiencies for different phase numbers for a multi-phase VR with respect to current loads. The vertical axis represents efficiency percentages (%), and the horizontal axis represents the load current (I) in amps (A). Element 405 is the legend for the graphical depictions. Lines 410, 415 and 420 correspond to efficiency curves for 1-phase, 2-phase and 3-phase VR operational modes, respectively. Each efficiency curve follows data points at various load currents. A comparison of lines 410 and 420 illustrates an efficiency cross-over point where a 3-phase VR demonstrates higher efficiency than that of a 1-phase VR when the load current is larger than cross-over point. Circle 425 indicates that efficiency cross-over point, which corresponds to a load current of approximately 15 A. Thus, graph 400 that efficiency may be maximized if the number of phases is minimized toward the lower range of load currents and maximized toward the higher range of load currents.

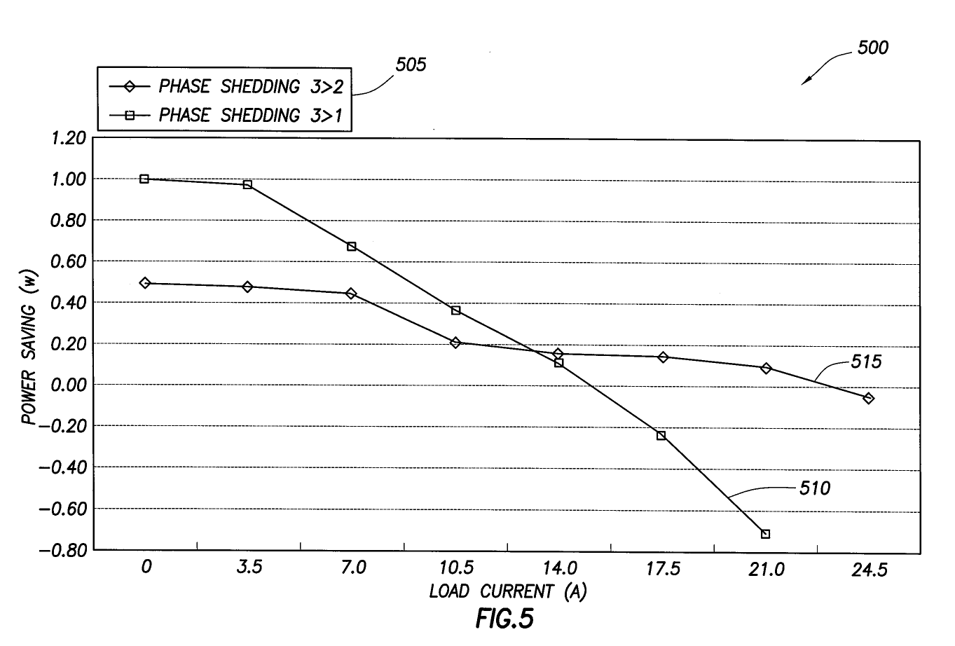

FIG. 5 shows a graph 500 of exemplary test data for a 3-phase memory VR showing power savings of phase shedding over a range of load currents. The vertical axis represents power savings in watts (W), and the horizontal axis represents the load current (I) in amps (A). Element 505 is the legend for the graphical depictions. Line 510 corresponds to a power savings curve showing the difference in power loss between a 3-phase configuration and a 1-phase configuration for different load currents. Line 515 corresponds to a power savings curve showing the difference in power loss between a 3-phase configuration and a 2-phase configuration for different load currents. Thus, graph 500 illustrates, with lines 510 and 515, that power savings may be maximized if the number of phases is minimized toward the lower range of load currents.

Certain embodiments of the present disclosure maximize the efficiency and power savings characteristics of multiphase VRs which are illustrated in FIGS. 4 and 5. For example, returning to FIG. 3, system 300 may be configured to select a number of potentially active phases for VR 310 based on identification and power information concerning the circuitry to be powered, where a plurality of different types of that circuitry may be installed into system 300. With start-up or initialization of system 300, identification information may be obtained concerning the type of circuitry actually installed, and an optimal number of active VR phases may be set according to a power inventory identification for the load configuration.

For example, identifiers for CPUs and/or memory circuitry may be updated with a new start-up or initialization. In mother board system side processes 305, a BMC or BIOS may read and/or receive the identity (ID) for CPUs and/or memory installed. The BMC may send the load ID to a controller, such as a CPLD, configured to control on board system operations. A determination may be made concerning the desired number of active phases based upon the power level requirements associated with the identified components. The BMC or CPLD may send phase shedding control signals to VR controller 320, for example, through a system management bus (e.g., SMBus) or a power management bus (e.g., PMBus) 350. In the alternative, the BMC or CPLD may communicate control signals directly to MOSFET drivers 325 through control signals 355, 360, 365. Accordingly, a number of phases used within VR 310 may be activated or deactivated dependent upon the device and/or circuitry identification information and associated power information.

A person of ordinary skill in the art, having the benefit of this disclosure, would appreciate that the techniques by which the circuit identification is obtained may be implemented and adjusted as desired, and the techniques by which the active phases are controlled can also be implemented and adjusted as desired, while still taking advantage of the phase control methods and systems described herein that select the number of active phases. For example, BIOS (basic input output system) software used for a system could read a circuit/device identifier from a register within an installed circuit/device and then report this information to a BMC or CPLD. Thus, the VR control of the present disclosure may be implemented using a variety of techniques, as desired.

System 300 may include closed loop control, as well as phase re-enable capability, in part by utilizing a temperature sensing function of VR 310 in conjunction with one or more predetermined temperature thresholds. VR 310 may also be configured to monitor operating conditions of each individual phase to provide indications of fault conditions such as an open phase, a shorted phase, or a thermal overload. Feedback monitoring of individual phases is represented by feedback lines 370A, B and C. VR 310 may also be configured to monitor operating conditions of output ripple voltage, which is represented by feedback line 375, for example.

Closed loop control of system 300 allows for re-enabling disabled phases to assist active phases when and if individual active phases exceed thermal capability for any reason. Exceeding a thermal threshold may be of particular concern after one or more phases have been disabled. Temperature sensing may enable more accurate determinations of individual phase status, especially when considering power or current do not represent all worst case conditions if other operating factors such as PCB temperature, air flow and/or other environmental factors are not considered.

Monitoring output voltage to ensure VR health prior to disabling phases may, in some cases, avoid data loss in information handling systems. For example, in some cases, phase shedding down to a single phase operation may result in a system shutdown is due to that single phase is not sufficiently operational. However, monitoring output voltage to ensure VR health prior to disabling phases may allow such a scenario to be avoided.

Temperature sensing may be implemented by using a digital signal for VR 310. For example, typical controllers, such as VR11 controllers currently available, may include a “VRHOT” temperature sensing function. VRHOT may be a comparator output from the VR controller that indicates when an NTC (negative temperature coefficient) resistor voltage has reached a certain threshold. Temperature sensing may be implemented by using an analog signal for VR 310. For example, typical controllers, such as VR11 controllers currently available, may include “TTsense” temperature sensing function. TTsense may be the analog voltage measured at the NTC resistor, and the analog voltage signal may be inversely proportional to the increase in temperature. The two pins, VRHOT and TTsense, may not be otherwise used by either the VR controller or information handling system in typical VR configurations currently available. Temperature sensing signals may be communicated from VR controller 320 to mother board system side processes 305 via lines 335, for example. Accordingly, temperature sensing of VR 310 may be used to monitor thermal conditions such as PCB temperature and air flow.

In mother board system side processes 305 block 340, a BMC or CPLD may receive one or more temperature signals, output ripple voltage signals, and/or phase failure signals. A determination may be made concerning the desired number of active phases based upon the signals received. At block 345, the BMC or CPLD may send phase shedding control signals to VR controller 320, for example, through SMBus or PMBus 350. In the alternative, the BMC or CPLD may communicate control signals directly to MOSFET drivers 325 through control signals 355, 360, 365. Accordingly, a number of phases used within VR 310 may be activated or deactivated dependent upon one or more temperature signals and/or phase failure signals.

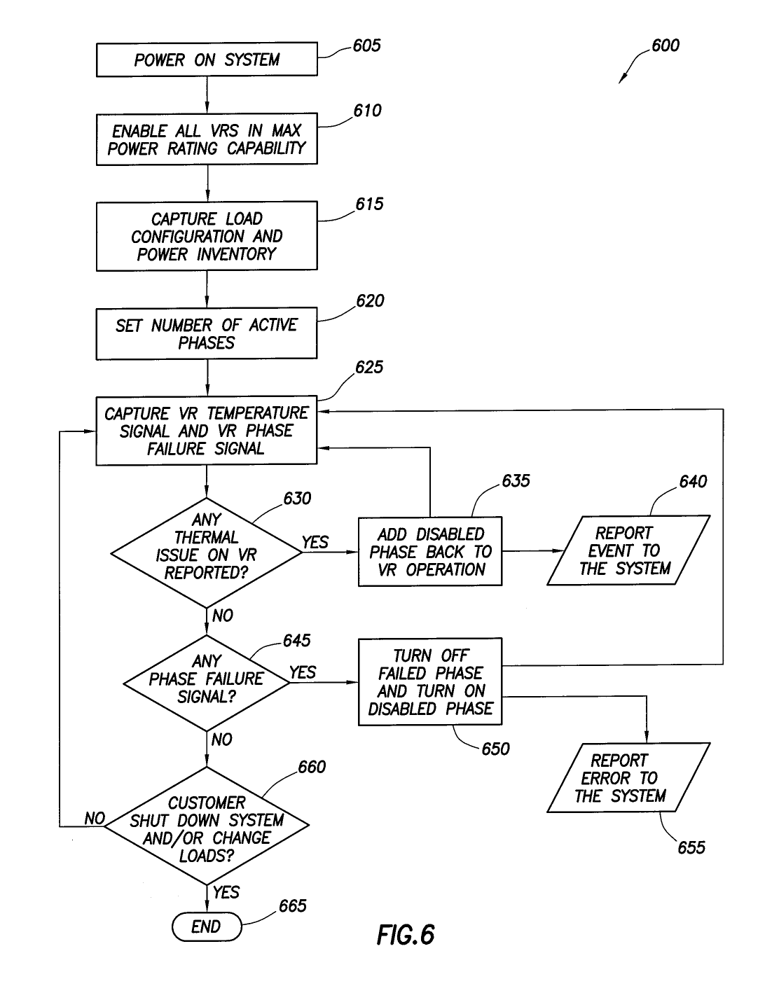

FIG. 6 shows a process flow diagram 600 illustrating one exemplary method of re-enabling phases under fault conditions for static and/or dynamic phase shedding applications in accordance with certain embodiments of the present disclosure. Step 605 represents the start-up of an information handling system. In step 610, one or more VRs may be enabled for providing maximum power rating capabilities. In step 615, the load configuration and/or the associated power inventory may be captured and determined. In step 620, a number of phases may be determined, and one or more phases may be disabled. As discussed above, an optimal number of phases may be set. As indicated above, one or more of the above steps could be implemented using a variety of techniques, including the use of one or more of a BMC, system BIOS and CPLD. Also for example, the system may employ dynamic phase shedding for lower power modes and/or lower current load operation.

In step 625, temperature, output voltage health, and/or phase failure signals may be received. In step 630, it may be determined whether any thermal issue has been reported. If a thermal issue has been reported, a previously disabled phase may be re-enabled and, thus, added back to VR operation in step 635. Thus, one or more disabled phases may be re-enabled to aid one or more phases that may be exceeding a thermal threshold. Information related to the event may be reported in step 640, and the process flow may return to step 625.

If a thermal issue has not been reported, whether any phase signal has been received may be determined in step 645. If a phase failure signal has been received, the failed phase may be turned off, and another previously disabled phase may be turned on in step 650. Information related to the event may be reported in step 655, and the process flow may return to step 625.

If a phase failure signal has not been received, it may be determined in step 660 whether a shut down command has been issued and/or whether a change of loads has occurred. If a shutdown command has been issued and/or a change of loads has occurred, the process may end, and the system may be shut down at step 665. Otherwise, the process may return to step 625 and the system may operate until shutdown. Thus, the system may override a phase shedding feature under various fault conditions to prevent data loss, or throttle the load to minimize customer exposure due to further VR degradation, when phase failures or instances of exceeding a thermal threshold have been detected.

As would be appreciated by one of ordinary skill in the art having the benefit of this disclosure, embodiment 600 may be modified in various ways. For example, certain embodiments may be used for recovery from phase failures even at maximum designed output load if there are redundant or hot spare phases available. In certain embodiments, various mechanisms may be deployed to isolate phases and throttle the system as required for maximum load configurations in the event of shorted phases. In certain embodiments, fault information may be used to alert a user of limited VR capability, which may be advantageous in the event a customer changes a load configuration, for example.

Thus, the systems and methods disclosed herein enable a high-efficiency, high-reliability power architecture. This disclosure provides for more intelligent VR embodiments that may include real-time monitoring or reporting of individual phase power signals and/or of output ripple voltage to ensure VR health prior to and/or after disabling and/or re-enabling one or more phases. This disclosure further provides for handling thermal conditions of phase shedding applications, factoring thermal considerations into a VR control loop, and handling thermal conditions in cases where possible thermal issues may arise for relatively low-end load phase shedding applications. This disclosure provides for handling fault conditions, for re-enabling phases under fault conditions, and for a high reliability VR where one or more disabled phases may act as redundant phases and may be re-enabled based on various fault conditions.

Although the present disclosure has been described in detail, it should be understood that various changes, substitutions, and alterations can be made hereto without departing from the spirit and the scope of the invention as defined by the appended claims. Various changes, substitutions, and alterations can be made to interfaces with multiple devices at one end and a single device at the other end without departing from the spirit and the scope of the invention.

What is claimed is:

1. A method for controlling a multi-phase voltage regulator, comprising:
activating one or more phases for the multi-phase voltage regulator;
detecting one or more conditions of the multi-phase voltage regulator;
activating one or more inactive phases based, at least in part, on the one or more conditions; and
controlling the multi-phase voltage regulator to provide regulated voltages to a load coupled to one or more output nodes of the multi-phase voltage regulator.

2. The method of claim 1, wherein the one or more conditions comprises a thermal condition.

3. The method of claim 1, wherein the one or more conditions comprises a fault condition.

4. The method of claim 3, comprising deactivating a failed phase based, at least in part, on the fault condition.

5. The method of claim 1, comprising reporting information related to the activating one or more inactive phases to a motherboard system device.

6. The method of claim 1, wherein the activating one or more phases for the multi-phase voltage regulator is based, at least in part, upon a load coupled to one or more output nodes.

7. The method of claim 1, wherein the load comprises one or more central processing units and one or more memory modules.

8. The method of claim 1, comprising monitoring one or more temperatures of each of the one or more phases.

9. The method of claim 1, comprising monitoring one or more voltages of each of the one or more phases.

10. A multi-phase voltage regulator, comprising:
a voltage regulator controller; and
a plurality of phase output stages coupled to the voltage regulator controller;
wherein the voltage regulator controller and the plurality of phase output stages are configured to provide regulated voltages at one or more output nodes; and
wherein the voltage regulator controller is configured to monitor one or more conditions of the plurality of phase output stages and to control one or more of the plurality of phase output stages based, at least in part, on the one or more conditions.

11. The multi-phase voltage regulator of claim 10, wherein the voltage regulator controller is configured to activate one or more of the plurality of phase output stages based, at least in part, on the one or more conditions.

12. The multi-phase voltage regulator of claim 10, wherein the voltage regulator controller is configured to deactivate one or more of the plurality of phase output stages based, at least in part, on the one or more conditions.

13. The multi-phase voltage regulator of claim 10, wherein the one or more conditions comprises a thermal condition.

14. The multi-phase voltage regulator of claim 10, wherein the one or more conditions comprises a fault condition.

15. The multi-phase voltage regulator of claim 10, wherein the voltage regulator controller is configured to report information related to the one or more conditions to a motherboard system device.

16. An information handling system comprising:
one or more processors;
a computer motherboard coupled to the one or more processors; and
a multi-phase voltage regulator coupled to the computer motherboard, wherein the multi-phase voltage regulator comprises:
a voltage regulator controller;
a plurality of phase output stages coupled to the voltage regulator controller;
wherein the voltage regulator controller and the plurality of phase output stages are configured to provide regulated voltages at one or more output nodes; and
wherein the voltage regulator controller is configured to monitor one or more conditions of the plurality of phase output stages and to control one or more of the plurality of phase output stages based, at least in part, on the one or more conditions.

17. The information handling system of claim 16, wherein the voltage regulator controller is configured to send one or more signals to a motherboard device, wherein the one or more signals are based, at least in part, on the one or more conditions.

18. The information handling system of claim 17, wherein the motherboard device is configured to send one or more control signals to the multi-phase voltage regulator, wherein the one or more control signals are based, at least in part, on the one or more conditions.

19. The information handling system of claim 18, wherein the multi-phase voltage regulator is configured to activate one or more of the plurality of phase output stages based, at least in part, on the one or more control signals.

20. The information handling system of claim 18, wherein the multi-phase voltage regulator is configured to deactivate one or more of the plurality of phase output stages based, at least in part, on the one or more control signals.
